(19) United States
(12) Patent Application Publication
(10) Pub. No.: US 2017/0058568 A1
(43) Pub. Date: Mar. 2, 2017

(54) ADJUSTABLE HOOK LATCH

(71) Applicant: Alcoa Inc., Pittsburgh, PA (US)

(72) Inventor: Thai Do, Laguna Niguel, CA (US)

(73) Assignee: Alcoa Inc., Pittsburgh, PA (US)

(21) Appl. No.: 15/251,535

(22) Filed: Aug. 30, 2016

Related U.S. Application Data
(60) Provisional application No. 62/212,669, filed on Sep. 1, 2015.

(51) Int. Cl. E05B 63/06; E05C 19/10

(52) U.S. Cl. CPC E05B 63/06; E05C 19/10

(57) ABSTRACT

A latch including a housing having a cylinder, a compression spring positioned within the cylinder, and a ball positioned at one end of the compression spring, a hook positioned slidably within the housing, and a star wheel positioned around the hook and having a plurality of holes formed therein. The ball under load from the spring aligns with and engages one of the holes of the star wheel to retain it in place. The star wheel is moveable rotatably such that the ball disengages the one of the holes of the star wheel to enable the hook to move axially and be adjusted relative to the housing, and the ball is adapted to engage another of the holes of the star wheel to retain the star wheel and prevent inadvertent rotation.

### CROSS-REFERENCE TO RELATED APPLICATION

This application relates to and claims the benefit of commonly-owned, co-pending U.S. Provisional Patent Application Ser. No. 62/212,669, filed Sep. 1, 2015, entitled “ADJUSTABLE HOOK LATCH,” the entirety of which is incorporated herein by reference.

### FIELD OF THE INVENTION

The present invention relates to latches and, more particularly, adjustable hook latches.

### SUMMARY OF THE INVENTION

The technical problem to be solved by the present invention is to provide an adjustable latch that offers a constant torque for adjusting the distance between two mounting points.

In an embodiment, a latch including a housing having a first end, a second end opposite the first end, a first chamber that extends from the first end to a location intermediate the first and second ends, a second chamber that extends from the first end to a location intermediate the first and second ends; a cylinder positioned within the first chamber, wherein the cylinder includes a body having a hollow portion, a compression spring positioned within the hollow portion of the body, and a ball positioned at one end of the compression spring proximate to the first end of the housing; a hook positioned slidably within the second chamber of the housing and including a shaft and a hook head at one end of the shaft; a star wheel positioned around the shaft of the hook and further positioned at the first end of the housing, wherein the star wheel includes a shaft and a flange located at one end of the shaft and having a face juxtaposed with the first end of the housing and a first plurality of holes formed within the face, wherein the ball aligns with and engages one of the first plurality of holes of the star wheel to retain the star wheel in a first position, wherein the star wheel is moveable rotatably relative to the housing, such that when the star wheel is rotated, the ball disengages the one of the first plurality of holes of the star wheel to enable the hook to move axially relative to the housing, and wherein, when the star wheel is rotated, the ball is adapted to engage another of the first plurality of holes of the star wheel to retain the star wheel in a second position; and a handle attached pivotally to the housing.

In an embodiment, the handle is attached to the housing by a pivot pin. In an embodiment, a mounting distance of the hook measured from a center of the pivot pin to a center point of the head of the hook is adjusted when the star wheel is rotated. In an embodiment, the cylinder includes a flange formed at one end of the body and having an opening, and the star wheel includes an annular portion, wherein a portion of the flange of the cylinder is positioned between the annular portion of the star wheel and the flange of the star wheel, and wherein the portion of the flange of the cylinder is positioned against a face of the annular portion of the star wheel, and wherein the ball protrudes through the opening of the flange of the cylinder. In an embodiment, the first plurality of holes of the star wheel is formed in a circular pattern. In an embodiment, the star wheel includes a circumferential edge and second plurality of holes formed within the circumferential edge, each of the second plurality of holes being adapted to receive an external tool for rotating the star wheel relative to the housing

In an embodiment, the handle is moveable between a closed position, in which the handle is attached releasably to the housing, and an open position, in which the handle is detached from the housing. In an embodiment, the housing includes a catch pin, and wherein the handle includes a trigger that is releasably engageable with the catch pin of the housing when the handle is in its closed position. In an embodiment, the handle includes a pair of opposing side members, each of which includes a slot formed therein, a pair of links, each having a first end and a second end opposite the first end of the link, and a bushing interconnecting the first ends of the links to one another, and wherein the second ends of the links are attached to the pivot pin, and wherein one end of the bushing extends through one of the slots and the other end of the bushing extends through the other one of the slots. In an embodiment, the hook is retracted when the handle is moved from its open position to its closed position.

In an embodiment, a latch including a housing having a first end, a second end opposite the first end, a first chamber that extends from the first end to a location intermediate the first and second ends, a second chamber that extends from the first end to a location intermediate the first and second ends; a cylinder positioned within the first chamber, wherein the cylinder includes a body having a hollow portion, a compression spring positioned within the hollow portion of the body, and a ball positioned at one end of the compression spring proximate to the first end of the housing; a hook positioned slidably within the second chamber of the housing and including a shaft and a hook head at one end of the shaft; and a star wheel positioned around the shaft of the hook and at the first end of the housing, wherein the star wheel includes a shaft and a flange located at one end of the shaft and having a face juxtaposed with the first end of the housing and a first plurality of holes formed within the face, wherein the ball aligns with and engages one of the first plurality of holes of the star wheel to retain the star wheel in a first position, wherein the star wheel is rotatably moveable relative to the housing, such that when the star wheel is rotated, the ball disengages the one of the first plurality of holes of the star wheel to enable the star wheel and the hook to move axially relative to the housing, and wherein the ball is adapted to engage another of the first plurality of holes of the star wheel to retain the star wheel in a second position.

In an embodiment, an adjustable hook latch having an anti-rotation feature that offers a constant torque for adjusting the distance between two mounting points. In an embodiment, the anti-rotation feature is self-enclosed so as to prevent damage thereto. In an embodiment, the hook latch is adapted for use in the aerospace field, such as aerospace doors, nacelles, etc. In other embodiments, the latch can be used in other fields and applications.

The latch of the present invention is advantageous over prior art latches in that it includes an adjustment feature, namely, a star wheel that is moveable rotatably such that the ball disengages one of the holes of the star wheel to enable the hook to move axially and be adjusted relative to the housing, while providing constant torque. The ball is adapted to engage another of the holes of the star wheel to retain the star wheel in place and prevent inadvertent rotation thereof.

### BRIEF DESCRIPTION OF THE DRAWINGS

FIG. 1 is a bottom perspective view of an adjustable hook latch in accordance with an embodiment, the hook latch being shown in a closed position;

FIG. 2 is a side cross-sectional view of the hook latch shown in FIG. 1; and

FIG. 3 is a bottom perspective view of the hook latch shown in FIG. 1, but shown in an open position.

### DETAILED DESCRIPTION OF THE DRAWINGS

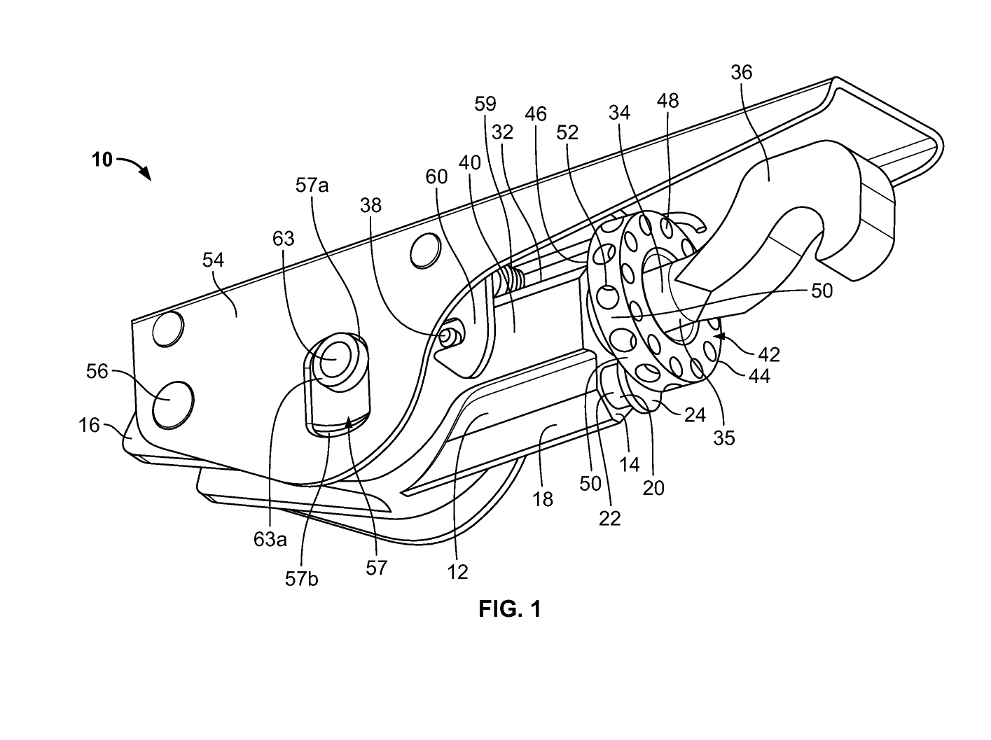

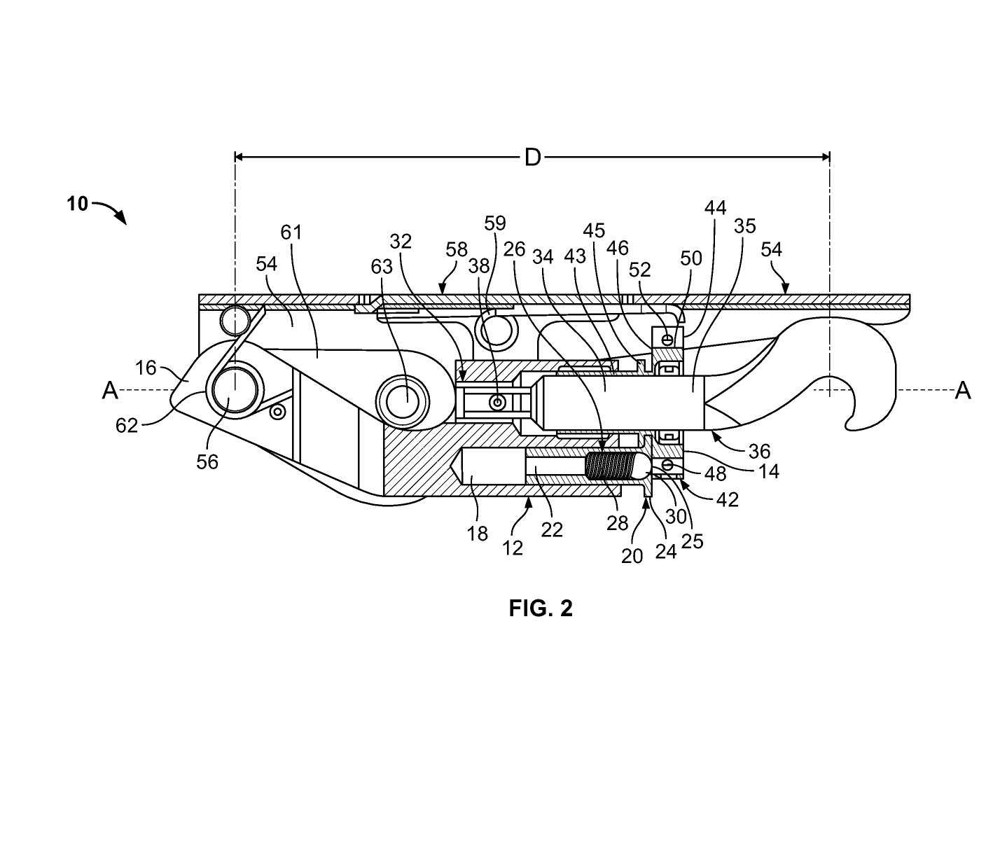

Referring to FIGS. 1 and 2, in an embodiment, a hook latch 10 having a housing 12 with a first end 14 and a second end 16 opposite the first end 14. In an embodiment, the housing 12 includes a first chamber 18 that extends from the first end 14 to a location intermediate the first and second ends 14, 16 of the housing 12. In an embodiment, the first chamber 18 is sized and shaped to receive slidably a cylinder 20. In an embodiment, the cylinder 20 includes an elongated body 22 and a flange 24 located at one end of the body 22. In an embodiment, the flange 24 is circular in shape. In an embodiment, the flange 24 includes a circular-shaped, centralized opening 25 formed therein. In an embodiment, the body 22 of the cylinder 20 includes a hollow portion 26 that is sized and shaped to receive a compression spring 28 and a ball 30 positioned at one end of the compression spring 28 and proximate to the first end 14 of the housing 12. In an embodiment, the opening 25 of the flange 24 is in communication with the hollow portion 26 of the cylinder 20. In an embodiment, the compression spring 28 and the ball 30 nest in the hollow portion 26 of the cylinder 20 which is guided by the first chamber 18. In an embodiment, a surface of the ball 30 protrudes through the opening 25 of the flange 24 of the body 22.

Still referring to FIGS. 1 and 2, in an embodiment, the housing 12 includes a second chamber 32 that extends from the first end 14 to a point intermediate the first and second ends 14, 16. In an embodiment, the second chamber 32 is positioned above the first chamber 18 relative to a longitudinal axis A-A of the housing 12, as oriented and shown in the Figures. In an embodiment, the second chamber 32 is sized and shaped to receive a hook 34 having a shaft 35 and a hook head 36 formed on an end of the shaft 35. In an embodiment, the second chamber 32 is sized and shaped to receive slidably the shaft 35 of the hook 34. In an embodiment, a catch pin 38 extends through one end of the shaft 35 of the hook 34 transversely to the longitudinal axis A-A of the housing 12 and protrudes outwardly from the housing 12 at opposite side portions 40 thereof (only one side portion 40 shown in FIG. 1).

In an embodiment, a star wheel 42 is positioned on the shaft 35 of the hook 34 and juxtaposed with the first end 14 of the housing 12. In an embodiment, the star wheel 42 includes a hollow, elongated shaft 43 which is sized and shaped to receive the shaft 35 of the hook 34, a flange 44 located at one end of the shaft 35, and an annular portion 45 extending outwardly from the shaft 35 and located proximate to the flange 44. In an embodiment, a portion of the flange 24 of the cylinder 20 is positioned between the annular portion 45 and the flange 44 of the star wheel 42. In an embodiment, the flange 44 of the star wheel 42 includes a face 46 with a first plurality of holes 48 that are each sized and shaped to receive the portion of the ball 30 exposed through the flange 24 of the cylinder 20, and a circumferential edge 50 having a second plurality of holes 52 that are each sized and shaped to receive an adjusting tool. In an embodiment, the holes of the first plurality of holes 48 are spaced apart from one another and form a circular pattern. In an embodiment, the star wheel 42 is adjustable rotatably either clockwise or counterclockwise relative to the longitudinal axis A-A of the housing 12. In an embodiment, a portion of the flange 24 of the cylinder 20 is positioned and trapped between the flange 44 of the star wheel 42 and the annular portion 45 of the star wheel 42 and against a face of the annular portion 45 of the star wheel 42 while under the load of the compression spring 28, while the ball 30 aligns with and engages one of the first plurality of holes 48 of the star wheel 42. In this regard, pressure from the compression spring 28 on the ball 30 prevents the star wheel 42 from rotating relative to the longitudinal axis A-A.

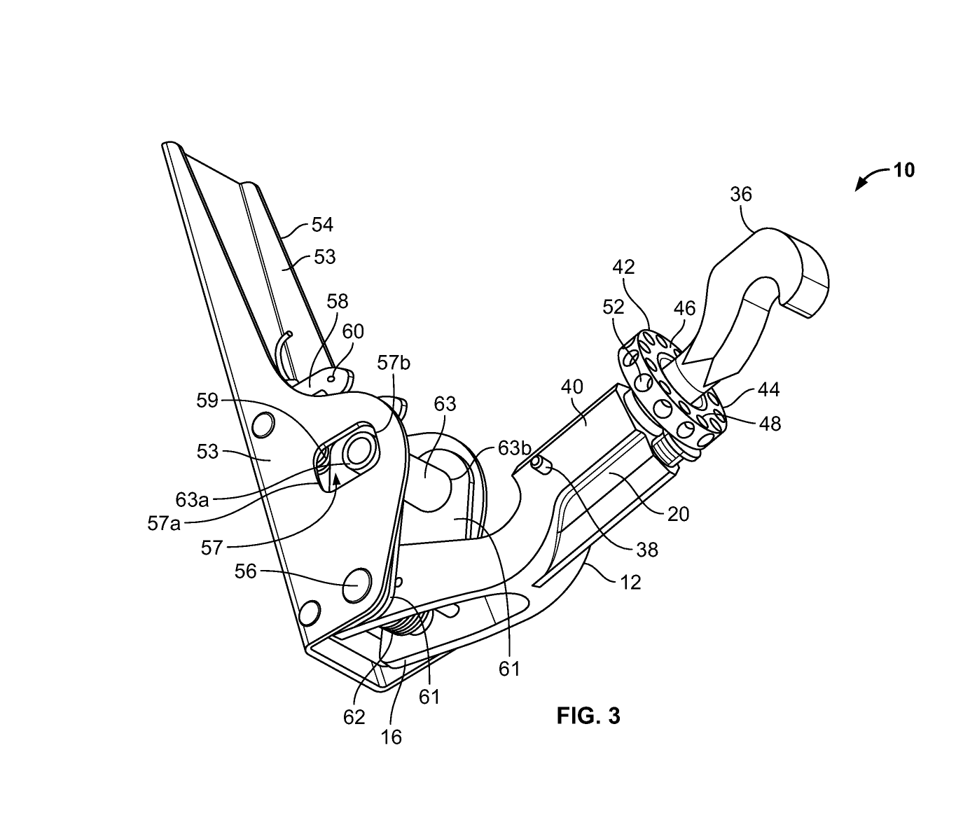

Referring to FIGS. 1 through 3, in an embodiment, the hook latch 10 includes a handle 54 attached rotatably to the second end 16 of the housing 12 by a pivot pin 56 extending through the second end 16 of the housing 12 and is moveable from a closed position to an open position, and vice-versa. In an embodiment, the handle 54 includes a trigger 58 having detents 60 that engage the catch pin 38 when the handle 54 is in its closed position. In an embodiment, the trigger 58 includes a trigger spring 59. In an embodiment, the handle 54 includes a pair of opposing side members 53, each of which includes a slot 57 formed therethrough. In an embodiment, each of the slots 57 is rounded rectangular-shaped and includes a first end 57a and a second end 57b opposite the first end 57a. In an embodiment, each of the slots 57 can be rectangular in shape or consist of any other suitable shape. In an embodiment, the handle 54 includes a pair of links 61 and a cylindrical-shaped bushing 63 interconnecting one end of each of the links 61 to one another. In an embodiment, one end 63a of the bushing 63 extends through one of the slots 57 and the other end 63b of the bushing 63 extends through the other one of the slots 57. In an embodiment, opposite ends of the links 61 are connected rotatably to the pivot pin 56. When the handle 54 is in its closed position, the ends 63a, 63b of the bushing 63 are positioned proximate to the ends 57a of the slots 57.

In an embodiment, when the trigger 58 is depressed, the detents 60 disengage the catch pin 38 to enable the handle 54 to move from the closed position to the open position, and, thus, retract the hook 34 from a first position to a second position. In this regard, when the handle 54 is moved from its closed position to its open position, the slots 57 move over the ends 63a, 63b of the bushing until the ends 63a, 63b engage the ends 57b of the slots 57 in order to rotate the links 61, which, in turn, retract the hook 34. In an embodiment, a back spring 62 surrounds the pivot pin 56 in order to maintain the handle 54 in its open position.

Referring to FIG. 2, the mounting distance D of the hook 34 along the longitudinal axis A-A (i.e., measured from the center of the pivot pin 56 to a center point of the hook head 36) can be adjusted by turning the star wheel 42 with a standard tool, which engages one or more of the second plurality of holes 52. In this regard, turning the star wheel 42 moves the star wheel 42 in a longitudinal direction along axis A-A and drives the cylinder 20 along with it, while the ball 30 disengages one of the first plurality of holes 48 of the star wheel 42 and then engages another (e.g., the next adjacent one) of the first plurality of holes 48 under constant spring load from the compression spring 28.

It should be understood that the embodiments described herein are merely exemplary and that a person skilled in the art may make many variations and modifications without departing from the spirit and scope of the invention. All such variations and modifications are intended to be included within the scope of the claims.

What is claimed is:

1. A latch, comprising:
a housing having a first end, a second end opposite the first end, a first chamber that extends from the first end to a location intermediate the first and second ends, a second chamber that extends from the first end to a location intermediate the first and second ends;
a cylinder positioned within the first chamber, wherein the cylinder includes a body having a hollow portion, a compression spring positioned within the hollow portion of the body, and a ball positioned at one end of the compression spring proximate to the first end of the housing;
a hook positioned slidably within the second chamber of the housing and including a shaft and a hook head at one end of the shaft;
a star wheel positioned around the shaft of the hook and further positioned at the first end of the housing, wherein the star wheel includes a shaft and a flange located at one end of the shaft and having a face juxtaposed with the first end of the housing and a first plurality of holes formed within the face, wherein the ball aligns with and engages one of the first plurality of holes of the star wheel to retain the star wheel in a first position,
wherein the star wheel is moveable rotatably relative to the housing, such that when the star wheel is rotated, the ball disengages the one of the first plurality of holes of the star wheel to enable the hook to move axially relative to the housing, and wherein, when the star wheel is rotated, the ball is adapted to engage another of the first plurality of holes of the star wheel to retain the star wheel in a second position; and
a handle attached pivotally to the housing.

2. The latch of claim 1, wherein the handle is attached to the housing by a pivot pin.

3. The latch of claim 2, wherein a mounting distance of the hook measured from a center of the pivot pin to a center point of the head of the hook is adjusted when the star wheel is rotated.

4. The latch of claim 3, wherein the cylinder includes a flange formed at one end of the body and having an opening, and the star wheel includes an annular portion, wherein a portion of the flange of the cylinder is positioned between the annular portion of the star wheel and the flange of the star wheel, and wherein the portion of the flange of the cylinder is positioned against a face of the annular portion of the star wheel, and wherein the ball protrudes through the opening of the flange of the cylinder.

5. The latch of claim 4, wherein the first plurality of holes of the star wheel are formed in a circular pattern.

6. The latch of claim 4, wherein the star wheel includes a circumferential edge and second plurality of holes formed within the circumferential edge, each of the second plurality of holes being adapted to receive an external tool for rotating the star wheel relative to the housing.

7. The latch of claim 6, wherein the handle is moveable between a closed position, in which the handle is attached releasably to the housing, and an open position, in which the handle is detached from the housing.

8. The latch of claim 7, wherein the housing includes a catch pin, and wherein the handle includes a trigger that is releasably engageable with the catch pin of the housing when the handle is in its closed position.

9. The latch of claim 8, wherein the handle includes a pair of opposing side members, each of which includes a slot formed therein, a pair of links, each having a first end and a second end opposite the first end of the link, and a bushing interconnecting the first ends of the links to one another, and wherein the second ends of the links are attached to the pivot pin, and wherein one end of the bushing extends through one of the slots and the other end of the bushing extends through the other one of the slots.

10. The latch of claim 9, wherein the hook is retracted when the handle is moved from its open position to its closed position.

11. A latch, comprising:
a housing having a first end, a second end opposite the first end, a first chamber that extends from the first end to a location intermediate the first and second ends, a second chamber that extends from the first end to a location intermediate the first and second ends;
a cylinder positioned within the first chamber, wherein the cylinder includes a body having a hollow portion, a compression spring positioned within the hollow portion of the body, and a ball positioned at one end of the compression spring proximate to the first end of the housing;
a hook positioned slidably within the second chamber of the housing and including a shaft and a hook head at one end of the shaft; and
a star wheel positioned around the shaft of the hook and at the first end of the housing, wherein the star wheel includes a shaft and a flange located at one end of the shaft and having a face juxtaposed with the first end of the housing and a first plurality of holes formed within the face, wherein the ball aligns with and engages one of the first plurality of holes of the star wheel to retain the star wheel in a first position,
wherein the star wheel is rotatably moveable relative to the housing, such that when the star wheel is rotated, the ball disengages the one of the first plurality of holes of the star wheel to enable the star wheel and the hook to move axially relative to the housing, and wherein the ball is adapted to engage another of the first plurality of holes of the star wheel to retain the star wheel in a second position.
